(19) United States
(12) Patent Application Publication
(10) Pub. No.: US 2025/0068177 A1
(43) Pub. Date: Feb. 27, 2025

(54) TRANSPORTATION SERVICE PROVISION WITH A VEHICLE FLEET

(71) Applicant: Uber Technologies, Inc., San Francisco, CA (US)

(72) Inventors: Prateek Jain, Santa Clara, CA (US); Kevin G. Babcock, Boulder, CO (US); Samantha Wan-Jou Lin, San Francisco, CA (US)

(21) Appl. No.: 18/813,682

(22) Filed: Aug. 23, 2024

Related U.S. Application Data
(60) Provisional application No. 63/589,615, filed on Oct. 11, 2023.
(60) Provisional application No. 63/583,562, filed on Sep. 18, 2023.
(60) Provisional application No. 63/578,653, filed on Aug. 24, 2023.

(51) Int. Cl. G05D 1/43; G06Q 50/47

(52) U.S. Cl. CPC G05D 1/43; G06Q 50/47

(57) ABSTRACT

Example implementations are directed to systems and methods for providing transportation service using an autonomous vehicle (AV) of a third-party system based on multiple stopping locations. A service assignment system receives, from a user, a service request from the user for a transportation service. The system can detect a location of the user and determine whether to share the user location with the third-party system. Based on the determining, the system provides either the user location or a selected pickup location, whereby the selected pickup location is a pickup location determined by the service assignment system or the user. In response to providing the user location or the selected pickup location, the system receives multiple AV stopping locations from the third-party system. An AV stopping location is selected from the multiple AV stopping locations. The AV is then triggered to travel to the selected AV stopping location.

### RELATED APPLICATIONS

This application claims the benefit of priority of U.S. Provisional Patent Application No. 63/578,653, filed Aug. 24, 2023; U.S. Provisional Patent Application No. 63/583,562, filed Sep. 18, 2023; and U.S. Provisional Patent Application No. 63/589,615, filed Oct. 11, 2023, each of which is hereby incorporated by reference herein in its entirety.

### FIELD

The present disclosure relates generally to transportation service provisioning and, more specifically, to transportation service provisioning using a third-party autonomous vehicle fleet.

### BACKGROUND

An autonomous vehicle (AV) is a vehicle that is capable of sensing its environment and operating some or all of the vehicle's controls based on the sensed environment. An autonomous vehicle includes sensors that capture signals describing the environment surrounding the vehicle. The autonomous vehicle processes the captured sensor signals to comprehend the environment and automatically operates some or all of the vehicle's controls based on the resulting information.

### DRAWINGS & APPENDICES

In the drawings, which are not necessarily drawn to scale, like numerals may describe similar components in different views. Like numerals having different letter suffixes may represent different instances of similar components. Some embodiments are illustrated by way of example, and not of limitation, in the figures of the accompanying drawings.

FIG. 1 is a diagram showing one example of an environment for managing a mixed fleet of vehicles using a service assignment system.

FIG. 2 is a block diagram of an example vehicle according to example aspects of the present disclosure.

FIG. 3A and FIG. 3B are example diagrams illustrating disadvantages of conventional systems that do not share a location of a user.

FIG. 4 is a flowchart illustrating a method 400 for selectively sharing user location and causing an AV to travel to a selected AV PU, according to example implementations.

FIG. 5 is a flowchart illustrating a method 500 of determining whether to share the location of the user, according to example implementations.

FIG. 6 is a block diagram showing one example of a software architecture for a computing device.

FIG. 7 is a block diagram illustrating a computing device hardware architecture.

### DESCRIPTION

Examples described herein are directed to systems and methods for using a computing system to manage and/or operate a fleet of vehicles to execute transportation services, where the fleet includes autonomous vehicles (AVs).

In an autonomous or semi-autonomous vehicle (collectively referred to as an AV), a vehicle autonomy system, sometimes referred to as an AV stack, controls one or more of braking, steering, or throttle of the vehicle. In a fully autonomous vehicle, the vehicle autonomy system assumes full control of the vehicle. In a semi-autonomous vehicle, the vehicle autonomy system assumes a portion of the vehicle control, with a human user (e.g., a vehicle operator) still providing some control input. Some autonomous vehicles can also operate in a manual mode, in which a human user provides all control inputs to the vehicle.

In some examples, a service assignment system receives requests for transportation services from one or more users. A transportation service may include transporting a payload, such as cargo and/or one or more passengers, from a service start location to a service end location. Examples of cargo can include food, packages, and/or the like. The service assignment system may match received transportation service requests from users with vehicles from the mixed fleet. When the service assignment system selects a vehicle for a requested transportation service, it may instruct the vehicle to begin executing the requested transportation service.

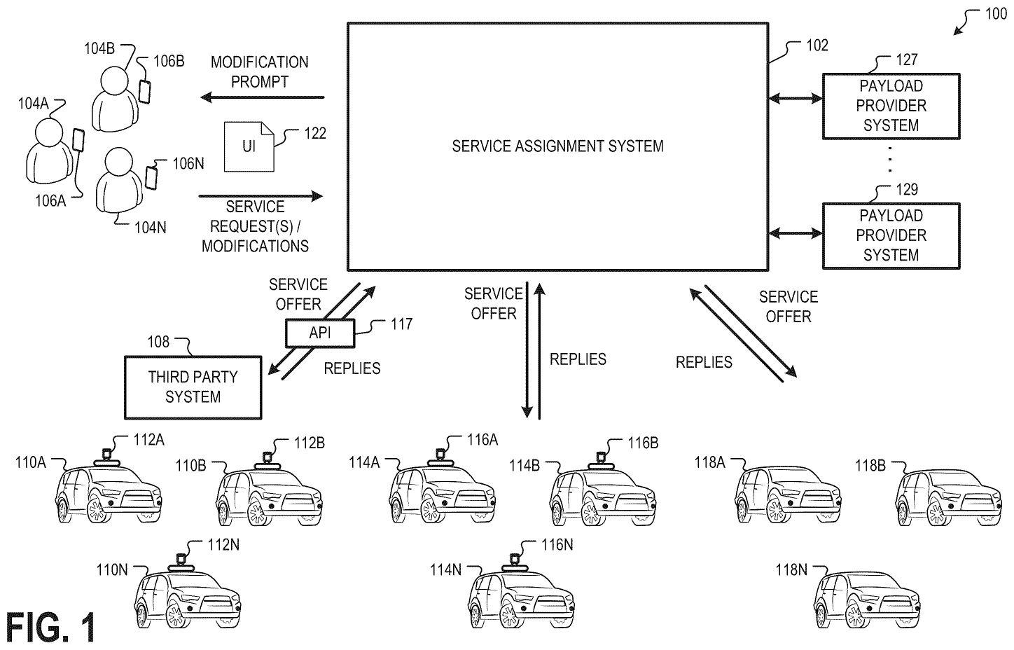

FIG. 1 is a diagram showing one example of an environment 100 for managing a mixed fleet of vehicles using a service assignment system 102. The environment 100 includes the service assignment system 102, a fleet of vehicles 110A, 110B, 110N, 114A, 114B, 114N, 118A, 118B, 118N, and users 104A, 104B, 104N. The fleet of vehicles may be a mixed fleet including AVs and human-driven vehicles. In this example, the fleet includes AVs 110A, 110B, 110N, 114A, 114B, 114N and human-driven vehicles 118A, 118B, 118N. Some or all of the vehicles 110A, 110B, 110N, 114A, 114B, 114N, 118A, 118B, 118N may be passenger vehicles, such as passenger trucks, cars, buses, or other similar vehicles. Also, some or all of the vehicles 110A, 110B, 110N, 114A, 114B, 114N, 118A, 118B, 118N may be delivery vehicles, such as vans, delivery trucks, tractor trailers, etc.

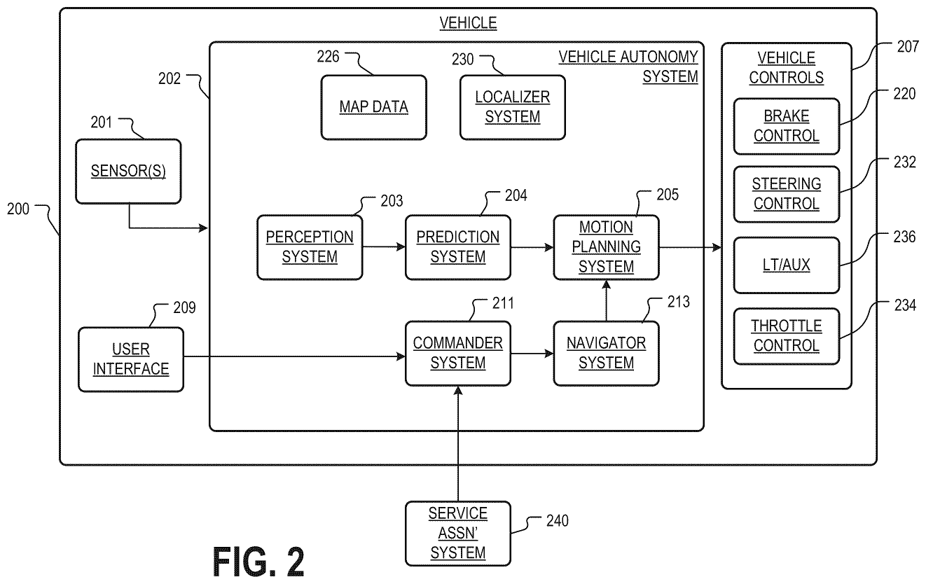

In this example, the AVs 110A, 110B, 110N, 114A, 114B, 114N include respective vehicle autonomy systems, described in more detail with respect to FIG. 2. The vehicle autonomy systems are configured to operate some or all of the controls of the AVs 110A, 110B, 110N, 114A, 114B, 114N (e.g., acceleration, braking, steering). In some examples, one or more of the AVs 110A, 110B, 110N, 114A, 114B, 114N are operable in different modes, where the vehicle autonomy system has differing levels of control over the AV 110A, 110B, 110N, 114A, 114B, 114N. Some AVs 110A, 110B, 110N, 114A, 114B, 114N may be operable in a fully autonomous mode in which the vehicle autonomy system has responsibility for all or most of the controls of the AV 110A, 110B, 110N, 114A, 114B, 114N. Some AVs 110A, 110B, 110N, 114A, 114B, 114N are operable in a semiautonomous mode that is in addition to or instead of the fully autonomous mode. In a semiautonomous mode, the vehicle autonomy system of an AV 110A, 110B, 110N, 114A, 114B, 114N is responsible for some of the vehicle controls while a human user or driver is responsible for other vehicle controls. In some examples, one or more of the AVs 110A, 110B, 110N, 114A, 114B, 114N are operable in a manual mode in which the human user is responsible for all controls of the AV 110A, 110B, 110N, 114A, 114B, 114N.

The AVs 110A, 110B, 110N, 114A, 114B, 114N include one or more respective remote-detection sensor sets 112A, 112B, 112N, 116A, 116B, 116N. The remote-detection sensor sets 112A, 112B, 112N, 116A, 116B, 116N include one or more remote-detection sensors that receive signals from the environment 100. The signals may be emitted by and/or reflected from objects in the environment 100, such as the ground, buildings, trees, and so forth. The remote-detection sensor sets 112A, 112B, 112N, 116A, 116B, 116N may include one or more active sensors, such as light imaging detection and ranging (LIDAR) sensors, radio detection and ranging (RADAR) sensors, and/or sound navigation and ranging (SONAR) sensors, that emit sound or electromagnetic radiation in the form of light or radio waves to generate return signals. Information about the environment 100 is extracted from the received signals. In some examples, the remote-detection sensor sets 112A, 112B, 112N, 116A, 116B, 116N include one or more passive sensors that receive signals that originated from other sources of sound or electromagnetic radiation. The remote-detection sensor sets 112A, 112B, 112N, 116A, 116B, 116N provide remote-detection sensor data that describes the environment 100. The AVs 110A, 110B, 110N, 114A, 114B, 114N can also include other types of sensors, for example, as described in more detail with respect to FIG. 2.

In some examples, the AVs 110A, 110B, 110N, 114A, 114B, 114N are of different types. Different types of AVs may have different capabilities. For example, the different types of AVs 110A, 110B, 110N, 114A, 114B, 114N can have different vehicle autonomy systems. This can include, for example, vehicle autonomy systems made by different manufacturers or designers, vehicle autonomy systems having different software versions or revisions, and so forth. Also, in some examples, the different types of AVs 110A, 110B, 110N, 114A, 114B, 114N can have different remote-detection sensor sets 112A, 112B, 112N, 116A, 116B, 116N. For example, one type of AV 110A, 110B, 110N, 114A, 114B, 114N may include a LIDAR remote-detection sensor, while another type may include stereoscopic cameras and omit a LIDAR remote-detection sensor. In some examples, different types of AVs 110A, 110B, 110N, 114A, 114B, 114N can also have different mechanical particulars. For example, one type of vehicle may have all-wheel drive, while another type may have front-wheel drive, etc.

In the example of FIG. 1, the AVs 110A, 110B, 110N are managed by a third-party system 108. The third-party system 108 may be implemented by an entity that manages or otherwise operates the AVs 110A, 110B, 110N. For example, service offers offering a transportation service to the AVs 110A, 110B, 110N may be directed from the service assignment system 102 to the third-party system 108. The third-party system 108 may communicate the service offers to the respective AVs 110A, 110B, 110N. Replies to service offers (e.g., messages accepting and/or declining an offered transportation service) may be sent from the third-party system 108 to the service assignment system 102. In some examples, the third-party system 108 may accept and/or decline a service offer on behalf of the AVs 110A, 110B, 110N. Although one third-party system 108 and associated AVs 110A, 110B, 110N are shown in FIG. 1, it will be appreciated that other examples of the environment 100 may include multiple third-party systems and associated AVs.

In some examples, communication between the service assignment system 102 and one or more third-party systems 108 is performed by an application programming interface (API) such as API 117. For example, service offers from the service assignment system 102 to one or more of the AVs 110A, 110B, 110N using one or more calls by the service assignment system 102 and/or by the third-party system 108 to the API 117. Similarly, replies from the third-party system 108 to the service assignment system 102 may involve one or more calls to the API 117 by the third-party system 108 or the service assignment system 102. For example, the third-party system 108 may reply to a service offer by accepting the offer or declining the offer. Also, although a single API 117 is shown in FIG. 1, it will be appreciated that some arrangements may include multiple APIs for managing communications between the third-party system 108 and the service assignment system 102. For example, different APIs may be used for different communication tasks.

In some examples, the service assignment system 102 may communicate directly with the AVs 114A, 114B, 114N (e.g., not through the third-party system 108). For example, the service assignment system 102 may provide service offers to and receive replies directly from the AVs 114A, 114B, 114N. The AVs 114A, 114B, 114N with which the service assignment system 102 communicates directly may be operated and/or managed by a third-party and/or by the entity implementing the service assignment system 102.

In the example of FIG. 1, the service assignment system 102 also communicates with human-driven vehicles 118A, 118B, 118N, for example, to provide service offers and receive replies. The service assignment system 102 may communicate with the vehicles 118A, 118B, 118N themselves (e.g., through an infotainment system or other suitable computing system of the vehicle) and/or with one or more of the human drivers of the vehicles 118A, 118B, 118N (e.g., via a user computing device or devices of the human drivers). It will be appreciated that FIG. 1 shows just one example of a mixed fleet and that different mixed fleets may have different numbers and proportions of AVs and human-driven vehicles.

The service assignment system 102 is programmed to receive service requests from the users 104A, 104B, 104N and offer requested transportation services to vehicles selected from the fleet of vehicles 110A, 110B, 110N, 114A, 114B, 114N, 118A, 118B, 118N as described herein. The service assignment system 102 can be or include one or more servers or other suitable computing devices. The service assignment system 102 is configured to receive transportation service requests from one or more users 104A, 104B, 104N. The users 104A, 104B, 104N make transportation service requests with user computing devices 106A, 106B, 106N. The user computing devices 106A, 106B, 106N can be or include any suitable computing device such as, for example, tablet computers, mobile telephone devices, laptop computers, desktop computers, etc. In some examples, the user computing devices 106A, 106B, 106N execute an application associated with a transportation service implemented with the service assignment system 102. The users 104A, 104B, 104N launch the application on the respective user computing devices 106A, 106B, 106N and utilize functionality of the application to make transportation service requests.

The service assignment system 102 is programmed to receive and process transportation service requests from the users 104A, 104B, 104N. Upon receiving a transportation service request, the service assignment system 102 may filter the fleet of vehicles 110A, 110B, 110N, 114A, 114B, 114N, 118A, 118B, 118N to select a set of one or more candidate vehicles. The candidate vehicles may include vehicles that are suitable, or potentially suitable, for executing the requested transportation service. From the set of candidate vehicles, the service assignment system 102 may select a vehicle or vehicles to which the requested transportation service will be offered. The service assignment system 102 may select the vehicle or vehicles based on any suitable criterion or criteria such as, for example, vehicle locations, vehicle cost to execute the requested transportation service, a prior acceptance rate of the vehicle and/or of vehicles of the same time, and so forth. In some examples, the service assignment system 102 selects a vehicle or vehicles to offer a transportation service using a route for the transportation service, which may be generated by the service assignment system 102, by the third-party system 108, and/or by any other suitable component of the environment 100.

The service assignment system 102 may select the candidate vehicles based on various criteria such as, for example, the availability of the various vehicles in the fleet, properties of the service request, user preferences, and/or the like. Properties of the service request may include, for example, the service start location, the service end location, the type of payload (e.g., size and weight of payload, number of passengers).

In some examples, the service assignment system 102 provides a user interface 122 to the users 104A, 104B, 104N via the respective user computing devices 106A, 106B, 106N. The UI 122 may provide functionality allowing the users to make service requests for transportation services. For example, the UI 122 may include fields in which a user 104A, 104B, 104N can provide request properties such as, for example, a service start location, a service end location, a description of the desired payload, and/or the like.

In some examples, a user 104A, 104B, 104N may request a transportation service that involves the delivery of a product, where the product is all or part of the payload of the transportation service. For example, a user 104A, 104B, 104N may request delivery of a meal from a restaurant or other provider, a delivery of a purchase from a store or other provider. In some examples, the service assignment system 102 is in communication with one or more payload provider systems 127, 129. Payload provider systems 127, 129 are associated with restaurants, stores, or other entities that provide payloads for transportation services, for example, where the payloads are delivered to the service end location.

In some examples, the UI 122 includes information about payload that can be provided by a payload provider system 127, 129. Consider an example in which a transportation service is to deliver prepared food via a payload provider system 127, 129. The UI 122 may include fields allowing the user 104A, 104B to select the payload provider system 127, 129 and/or items from the menu of the payload provider system 127, 129 for delivery. The properties of the service request, then, can include the identified payload. When a vehicle accepts the requested transportation service, the service assignment system 102 may provide an instruction to the selected payload provider system 127, 129 requesting preparation of the payload and providing information about the vehicle that will pick up the payload for delivery.

The example environment 100 describes a mixed fleet including AVs 110A, 110B, 110N managed by the third-party system 108, AVs, AVs managed by the service assignment system 102, and human-driven vehicles 118A, 118B, 118N. It will be appreciated, however, that in various examples, the environment 100 may include more or fewer different types of vehicles. For example, in some arrangements, the service assignment system 102 may offer transportation services to multiple third-party fleets of autonomous vehicles via multiple third-party systems (e.g., and multiple APIs or API instances). In other examples, some or all of the vehicle types shown in the environment 100 be omitted. For example, the service assignment system 102 may be configured to offer service assignments only to autonomous vehicles or only to autonomous vehicles managed by third-party systems, or permutations thereof.

In some examples, the service assignment system 102 may arrange transportation services by matching the user 104A, 104B, 104N with an AV 110A, 110B, 110N of the third-party provider (e.g., managed by the third-party system 108). For example, the service assignment system 102 may receive a transportation service request from the user 104A, 104B, 104N. The service assignment system 102 may match the requested transportation service to an AV 110A, 110B, 110N managed by the third-party system 108. For example, the selected AV 110A, 110B, 110N may be an AV that is positioned near the requested pickup position of the user 104A, 104B, 104N.

In some examples, the service assignment system 102 may perform a pre-offer check. The pre-offer check may include determining that the selected AV 110A, 110B, 110N is capable of performing a transportation service requested by a user 104A, 104B, 104N. The service assignment system 102 may direct a pre-offer check to the third-party system 108. In some cases, the pre-offer check include a location of the user 104A, 104B, 104N and/or a determined pickup location (e.g., service start location) for the user 104A, 104B, 104N as well as a drop-off location (e.g., service end location). The determined pickup location can be selected by the user 104A, 104B, 104N or be determined by the service assignment system 102. The third-party system 108 may respond to the pre-offer check by providing, for example, an estimated time of arrival at a pickup location (ETA), an estimated time of arrival at a destination (ETD), one or more stopping locations (e.g., pickup or drop-off locations for the transportation service, and/or other information about how the third-party system 108 would fulfill the transportation service. In other implementations, an offer can be made directly to the third-party system 108 without the use of the pre-offer check. Thus, the offer can include the location of the user 104A, 104B, 104N and/or the determined pickup location (e.g., service start location) for the user 104A, 104B, 104N.

The service assignment system 102 may perform a service quality check based on the response of the third-party system 108. For example, the service assignment system 102 may compare the response of the third-party system 108 to one or more quality criteria. If the response of the third-party system 108 meets the one or more quality criteria, then the service assignment system may make an offer to the third-party system 108 and the user 104A, 104B, 104N.

The offer may be accepted by the user 104A, 104B, 104N and may be accepted by the third-party system 108 on behalf of an autonomous vehicle 110A, 110B, 110N being managed by the third-party system 108. When the offer is accepted by the third-party system 108, the acceptance may include terms of the service, for example, related to ETA, ETD, a stopping location or stopping locations, and/or the like.

The service assignment system 102 may perform a service quality criteria check by comparing service quality criteria to the terms of the service received from the third-party system 108. In some examples, if the terms of the service provided by the third-party system 108 do not meet the service quality criteria, then the service assignment system 102 may cancel the offer to the third-party system 108. For example, the service assignment system 102 may assign the requested transportation service to another vehicle.

In some examples, the terms of the service received from the third-party system 108 in response to the offer may include more than one potential stopping locations for fulfilling the transportation service. In some examples, the service assignment system 102 may select a stopping location from those provided by the third-party system 108. The service assignment system 102 may provide an indication of the selected stopping location to the third-party system 108 and may provide an indication of the selected stopping location to the user 104A, 104B, 104N. The selected stopping location then causes the AV to travel to the selected stopping location (e.g., pickup location (PU)) to pick up the cargo or a passenger and to travel to a second stopping location (e.g., drop-off location (DO)) to drop-off the cargo or passenger.

FIG. 2 depicts a block diagram of an example vehicle 200 according to example aspects of the present disclosure. The vehicle 200 shows one example arrangement of the AVs 110A, 110B, 110N, 114A, 114B, 114N of FIG. 1. The vehicle 200 includes one or more sensors 201, a vehicle autonomy system 202, and one or more vehicle controls 207. The vehicle 200 is an autonomous vehicle, as described herein. The example vehicle 200 shows just one example arrangement of an autonomous vehicle. In some examples, autonomous vehicles of different types can have different arrangements.

The vehicle autonomy system 202 includes a commander system 211, a navigator system 213, a perception system 203, a prediction system 204, a motion planning system 205, and a localizer system 230 that cooperate to perceive the surrounding environment of the vehicle 200 and determine a motion plan for controlling the motion of the vehicle 200 accordingly.

The vehicle autonomy system 202 is engaged to control the vehicle 200 or to assist in controlling the vehicle 200. In particular, the vehicle autonomy system 202 receives sensor data from the one or more sensors 201, attempts to comprehend the environment surrounding the vehicle 200 by performing various processing techniques on data collected by the sensors 201, and generates an appropriate route through the environment. The vehicle autonomy system 202 sends commands to control the one or more vehicle controls 207 to operate the vehicle 200 according to the route.

Various portions of the vehicle autonomy system 202 receive sensor data from the one or more sensors 201. For example, the sensors 201 may include remote-detection sensors as well as motion sensors such as an inertial measurement unit (IMU), one or more encoders, or one or more odometers. The sensor data includes information that describes the location of objects within the surrounding environment of the vehicle 200, information that describes the motion of the vehicle 200, etc.

The sensors 201 may also include one or more remote-detection sensors or sensor systems, such as a LIDAR system, a RADAR system, one or more cameras, etc. As one example, a LIDAR system of the one or more sensors 201 generates sensor data (e.g., remote-detection sensor data) that includes the location (e.g., in three-dimensional space relative to the LIDAR system) of a number of points that correspond to objects that have reflected a ranging laser. For example, the LIDAR system measures distances by measuring the Time of Flight (TOF) that it takes a short laser pulse to travel from the sensor to an object and back, calculating the distance from the known speed of light.

As another example, a RADAR system of the one or more sensors 201 generates sensor data (e.g., remote-detection sensor data) that includes the location (e.g., in three-dimensional space relative to the RADAR system) of a number of points that correspond to objects that have reflected ranging radio waves. For example, radio waves (e.g., pulsed or continuous) transmitted by the RADAR system reflect off an object and return to a receiver of the RADAR system, giving information about the object's location and speed. Thus, a RADAR system provides useful information about the current speed of an object.

As yet another example, one or more cameras of the one or more sensors 201 may generate sensor data (e.g., remote-detection sensor data) including still or moving images. Various processing techniques (e.g., range imaging techniques such as structure from motion, structured light, stereo triangulation, and/or other techniques) can be performed to identify the location (e.g., in three-dimensional space relative to the one or more cameras) of a number of points that correspond to objects that are depicted in an image or images captured by the one or more cameras. Other sensor systems can identify the location of points that correspond to objects as well.

As another example, the one or more sensors 201 can include a positioning system. The positioning system determines a current position of the vehicle 200. The positioning system can be any device or circuitry for analyzing the position of the vehicle 200. For example, the positioning system can determine a position by using one or more of inertial sensors, a satellite positioning system such as the Global Positioning System (GPS), a positioning system based on IP address, triangulation and/or proximity to network access points or other network components (e.g., cellular towers, Wi-Fi access points), and/or other suitable techniques. The position of the vehicle 200 can be used by various systems of the vehicle autonomy system 202.

Thus, the one or more sensors 201 are used to collect sensor data that includes information that describes the location (e.g., in three-dimensional space relative to the vehicle 200) of points that correspond to objects within the surrounding environment of the vehicle 200. In some implementations, the sensors 201 can be positioned at different locations on the vehicle 200. As an example, in some implementations, one or more cameras and/or LIDAR sensors can be located in a pod or other structure that is mounted on a roof of the vehicle 200, while one or more RADAR sensors can be located in or behind the front and/or rear bumper(s) or body panel(s) of the vehicle 200. As another example, one or more cameras can be located at the front or rear bumper(s) of the vehicle 200. Other locations can be used as well.

The localizer system 230 receives some or all of the sensor data from the sensors 201 and generates vehicle poses for the vehicle 200. A vehicle pose describes a position and attitude of the vehicle 200. The vehicle pose (or portions thereof) can be used by various other components of the vehicle autonomy system 202 including, for example, the perception system 203, the prediction system 204, the motion planning system 205, and the navigator system 213.

The position of the vehicle 200 is a point in a three-dimensional space. In some examples, the position is described by values for a set of Cartesian coordinates, although any other suitable coordinate system may be used. The attitude of the vehicle 200 generally describes the way in which the vehicle 200 is oriented at its position. In some examples, attitude is described by a yaw about the vertical axis, a pitch about a first horizontal axis, and a roll about a second horizontal axis. In some examples, the localizer system 230 generates vehicle poses periodically (e.g., every second, every half second). The localizer system 230 appends time stamps to vehicle poses, where the time stamp for a pose indicates the point in time that is described by the pose. The localizer system 230 generates vehicle poses by comparing sensor data (e.g., remote-detection sensor data) to map data 226 describing the surrounding environment of the vehicle 200.

In some examples, the localizer system 230 includes one or more pose estimators and a pose filter. Pose estimators generate pose estimates by comparing remote-detection sensor data (e.g., LIDAR, RADAR) to map data. The pose filter receives pose estimates from the one or more pose estimators as well as other sensor data such as, for example, motion sensor data from an IMU, encoder, or odometer. In some examples, the pose filter executes a Kalman filter or machine learning algorithm to combine pose estimates from the one or more pose estimators with motion sensor data to generate vehicle poses. In some examples, pose estimators generate pose estimates at a frequency less than the frequency at which the localizer system 230 generates vehicle poses. Accordingly, the pose filter generates some vehicle poses by extrapolating from a previous pose estimate utilizing motion sensor data.

Vehicle poses and/or vehicle positions generated by the localizer system 230 are provided to various other components of the vehicle autonomy system 202. For example, the commander system 211 may utilize a vehicle position to determine whether to respond to a call from a service assignment system 240.

The commander system 211 determines a set of one or more target locations that are used for routing the vehicle 200. The target locations are determined based on user input received via a user interface 209 of the vehicle 200. The user interface 209 may include and/or use any suitable input/output device or devices. In some examples, the commander system 211 determines the one or more target locations considering data received from the service assignment system 240. The service assignment system 240 is programmed to provide instructions to multiple vehicles, for example, as part of a fleet of vehicles for moving passengers and/or cargo. Data from the service assignment system 240 can be provided via a wireless network, for example.

The navigator system 213 receives one or more target locations from the commander system 211 and map data 226. The map data 226, for example, provides detailed information about the surrounding environment of the vehicle 200. The map data 226 provides information regarding identity and location of different roadways and roadway elements. A roadway is a place where the vehicle 200 can drive and may include, for example, a road, a street, a highway, a lane, a parking lot, or a driveway. Routing graph data is a type of map data 226.

From the one or more target locations and the map data 226, the navigator system 213 generates route data describing a route for the vehicle 200 to take to arrive at the one or more target locations. In some implementations, the navigator system 213 determines route data using one or more path-planning algorithms based on costs for graph elements/corresponding roadway elements, as described herein. For example, a cost for a route can indicate a time of travel, risk of danger, or other factor associated with adhering to a particular proposed route. Route data describing a route is provided to the motion planning system 205, which commands the vehicle controls 207 to implement the route or route extension, as described herein. The navigator system 213 can generate routes as described herein using a general-purpose routing graph and routing graph modification data. Also, in examples where route data is received from the service assignment system 240, that route data can also be provided to the motion planning system 205.

The perception system 203 detects objects in the surrounding environment of the vehicle 200 based on sensor 201 data, the map data 226, and/or vehicle poses provided by the localizer system 230. For example, the map data 226 used by the perception system 203 describes roadways and segments thereof and may also describe buildings or other items or objects (e.g., lampposts, crosswalks, curbing); location and directions of traffic lanes or lane segments (e.g., the location and direction of a parking lane, a turning lane, a bicycle lane, or other lanes within a particular roadway); traffic control data (e.g., the location and instructions of signage, traffic lights, or other traffic control devices); and/or any other map data that provides information that assists the vehicle autonomy system 202 in comprehending and perceiving its surrounding environment and its relationship thereto.

In some examples, the perception system 203 determines state data for one or more of the objects in the surrounding environment of the vehicle 200. State data describes a current state of an object (also referred to as features of the object). The state data for each object describes, for example, an estimate of the object's current location (also referred to as position); current speed (also referred to as velocity); current acceleration; current heading; current orientation; size/shape/footprint (e.g., as represented by a bounding shape such as a bounding polygon or polyhedron); type/class (e.g., vehicle, pedestrian, bicycle, or other); yaw rate; distance from the vehicle 200; minimum path to interaction with the vehicle 200; minimum time duration to interaction with the vehicle 200; and/or other state information.

In some implementations, the perception system 203 determines state data for each object over a number of iterations. In particular, the perception system 203 updates the state data for each object at each iteration. Thus, the perception system 203 detects and tracks objects, such as other vehicles, that are proximate to the vehicle 200 over time.

The prediction system 204 is configured to predict one or more future positions for an object or objects in the environment surrounding the vehicle 200 (e.g., an object or objects detected by the perception system 203). The prediction system 204 generates prediction data associated with one or more of the objects detected by the perception system 203. In some examples, the prediction system 204 generates prediction data describing each of the respective objects detected by the perception system 203.

Prediction data for an object is indicative of one or more predicted future locations of the object. For example, the prediction system 204 may predict where the object will be located within the next 5 seconds, 30 seconds, 200 seconds, etc. Prediction data for an object may indicate a predicted trajectory (e.g., predicted path) for the object within the surrounding environment of the vehicle 200. For example, the predicted trajectory (e.g., path) can indicate a path along which the respective object is predicted to travel over time (and/or the speed at which the object is predicted to travel along the predicted path). The prediction system 204 generates prediction data for an object, for example, based on state data generated by the perception system 203. In some examples, the prediction system 204 also considers one or more vehicle poses generated by the localizer system 230 and/or map data 226.

In some examples, the prediction system 204 uses state data indicative of an object type or classification to predict a trajectory for the object. As an example, the prediction system 204 can use state data provided by the perception system 203 to determine that a particular object (e.g., an object classified as a vehicle) approaching an intersection and maneuvering into a left-turn lane intends to turn left. In such a situation, the prediction system 204 predicts a trajectory (e.g., path) corresponding to a left turn for the vehicle such that the vehicle turns left at the intersection. Similarly, the prediction system 204 determines predicted trajectories for other objects, such as bicycles, pedestrians, parked vehicles, etc. The prediction system 204 provides the predicted trajectories associated with the object(s) to the motion planning system 205.

In some implementations, the prediction system 204 is a goal-oriented prediction system 204 that generates one or more potential goals, selects one or more of the most likely potential goals, and develops one or more trajectories by which the object can achieve the one or more selected goals. For example, the prediction system 204 can include a scenario generation system that generates and/or scores the one or more goals for an object, and a scenario development system that determines the one or more trajectories by which the object can achieve the goals. In some implementations, the prediction system 204 can include a machine-learned goal-scoring model, a machine-learned trajectory development model, and/or other machine-learned models.

The motion planning system 205 commands the vehicle controls 207 based at least in part on the predicted trajectories associated with the objects within the surrounding environment of the vehicle 200, the state data for the objects provided by the perception system 203, vehicle poses provided by the localizer system 230, the map data 226, and route or route extension data provided by the navigator system 213. Stated differently, given information about the current locations of objects and/or predicted trajectories of objects within the surrounding environment of the vehicle 200, the motion planning system 205 determines control commands for the vehicle 200 that best navigate the vehicle 200 along the route or route extension relative to the objects at such locations and their predicted trajectories on acceptable roadways.

In some implementations, the motion planning system 205 can also evaluate one or more cost functions and/or one or more reward functions for each of one or more candidate control commands or sets of control commands for the vehicle 200. Thus, given information about the current locations and/or predicted future locations/trajectories of objects, the motion planning system 205 can determine a total cost (e.g., a sum of the cost(s) and/or reward(s) provided by the cost function(s) and/or reward function(s)) of adhering to a particular candidate control command or set of control commands. The motion planning system 205 can select or determine a control command or set of control commands for the vehicle 200 based at least in part on the cost function(s) and the reward function(s). For example, the motion plan that minimizes the total cost can be selected or otherwise determined.

In some implementations, the motion planning system 205 can be configured to iteratively update the route or route extension for the vehicle 200 as new sensor data is obtained from the one or more sensors 201. For example, as new sensor data is obtained from the one or more sensors 201, the sensor data can be analyzed by the perception system 203, the prediction system 204, and the motion planning system 205 to determine the motion plan.

The motion planning system 205 can provide control commands to the one or more vehicle controls 207. For example, the one or more vehicle controls 207 can include throttle systems, brake systems, steering systems, and other control systems, each of which can include various vehicle controls (e.g., actuators or other devices that control gas flow, steering, and braking) to control the motion of the vehicle 200. The various vehicle controls 207 can include one or more controllers, control devices, motors, and/or processors.

The vehicle controls 207 include a brake control module 220. The brake control module 220 is configured to receive a braking command and bring about a response by applying (or not applying) the vehicle brakes. In some examples, the brake control module 220 includes a primary system and a secondary system. The primary system receives braking commands and, in response, brakes the vehicle 200. The secondary system may be configured to determine a failure of the primary system to brake the vehicle 200 in response to receiving the braking command.

A steering control system 232 is configured to receive a steering command and bring about a response in the steering mechanism of the vehicle 200. The steering command is provided to a steering system to provide a steering input to steer the vehicle 200.

A lighting/auxiliary control module 236 receives a lighting or auxiliary command. In response, the lighting/auxiliary control module 236 controls a lighting and/or auxiliary system of the vehicle 200. Controlling a lighting system may include, for example, turning on, turning off, or otherwise modulating headlights, parking lights, running lights, etc. Controlling an auxiliary system may include, for example, modulating windshield wipers, a defroster, etc.

A throttle control system 234 is configured to receive a throttle command and bring about a response in the engine speed or other throttle mechanism of the vehicle. For example, the throttle control system 234 can instruct an engine and/or engine controller, or other propulsion system component, to control the engine or other propulsion system of the vehicle 200 to accelerate, decelerate, or remain at its current speed.

Each of the perception system 203, the prediction system 204, the motion planning system 205, the commander system 211, the navigator system 213, and the localizer system 230 can be included in or otherwise be a part of the vehicle autonomy system 202 configured to control the vehicle 200 based at least in part on data obtained from the one or more sensors 201. For example, data obtained by the one or more sensors 201 can be analyzed by each of the perception system 203, the prediction system 204, and the motion planning system 205 in a consecutive fashion in order to control the vehicle 200. While FIG. 2 depicts elements suitable for use in a vehicle autonomy system according to example aspects of the present disclosure, one of ordinary skill in the art will recognize that other vehicle autonomy systems can be configured to control an autonomous vehicle based on sensor data.

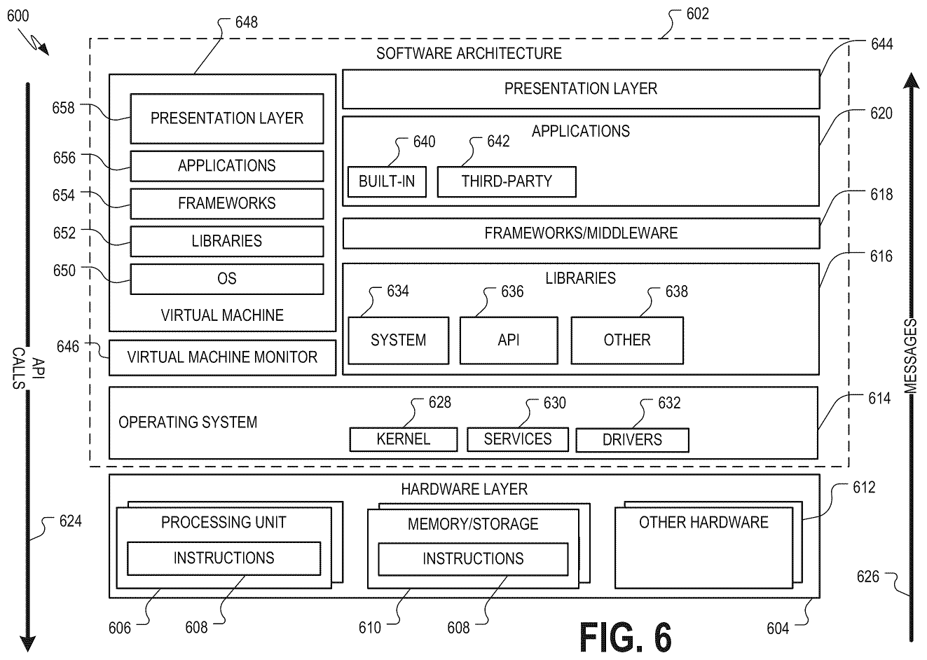

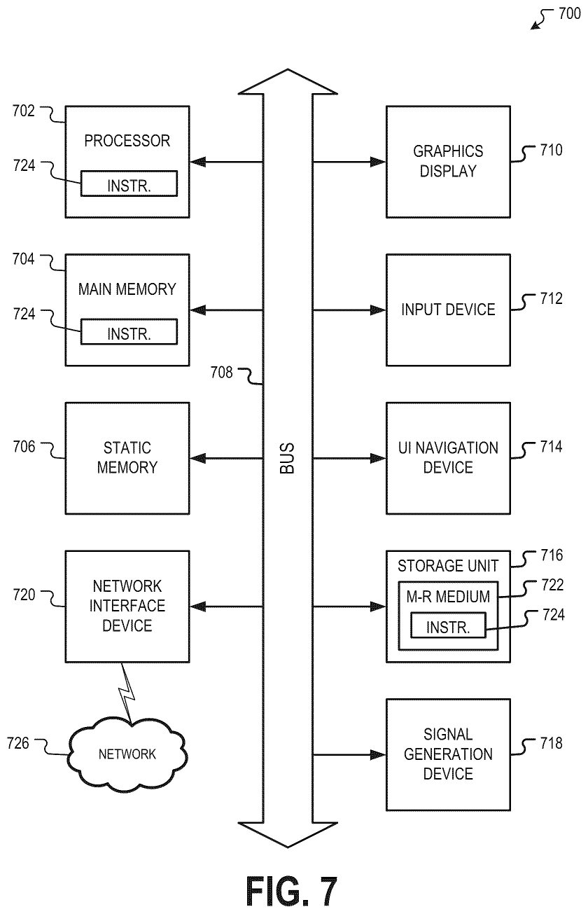

The vehicle autonomy system 202 includes one or more computing devices, which may implement all or parts of the perception system 203, the prediction system 204, the motion planning system 205, and/or the localizer system 230. Descriptions of hardware and software configurations for computing devices to implement the vehicle autonomy system 202 and/or the service assignment system 102 of FIG. 1 are provided herein with reference to FIGS. 6 and 7.

In human transportation implementations (e.g., ride sharing implementations), long walking distances and being surprised by the need to walk to a pickup location (or final destination from a drop-off location) are primary causes of users having a subpar AV experience. This potentially leads to the users canceling future AV rides. AVs can be constrained to traveling on certain roads and only stopping at certain locations. Thus, pickup or drop-off locations (PUDOs) where AVs can stop may not be at a service start location or service end location originally selected by the user or suggested by the service assignment system 102.

In implementations where the AVs are under the control of the third-party system 108, data may not be fully shared between the service assignment system 102 and the third-party system 108. This can be caused by data privacy and/or confidentiality constraints. For example, the service assignment system 102 may not share a user's actual location (e.g., GPS coordinates) in all instances, while the third-party system 108 may not share each AVs' operational constraints. As such, the information is distributed.

In a conventional flow, the user may initially select a pickup location (PU), which can be a PU suggested by the service assignment system 102. The selected PU is sent to the third-party system 108, which can respond with an offering of an AV stopping location which may be at or near the selected PU. Because the service assignment system 102 has imperfect or limited data about where the AVs can stop, this process may not result in an optimum stopping location given a user's actual location (also referred to as “user location”). In other words, where the AV can stop may not be near the initially selected pickup location. This may cause the user to cancel the transportation service after it has been established. Cancellation of the transportation service after an AV is already assigned and traveling to the AV stopping location causes inefficiencies in operation of the AV and in the overall utilization of third-party AVs. For example, the cancellation will prevent the AV from accepting a different transportation service and/or may cause the AV to travel away from a next transportation service, thus requiring the AV to spend more time and energy (e.g., fuel) to arrive at a stopping location of the next transportation service.

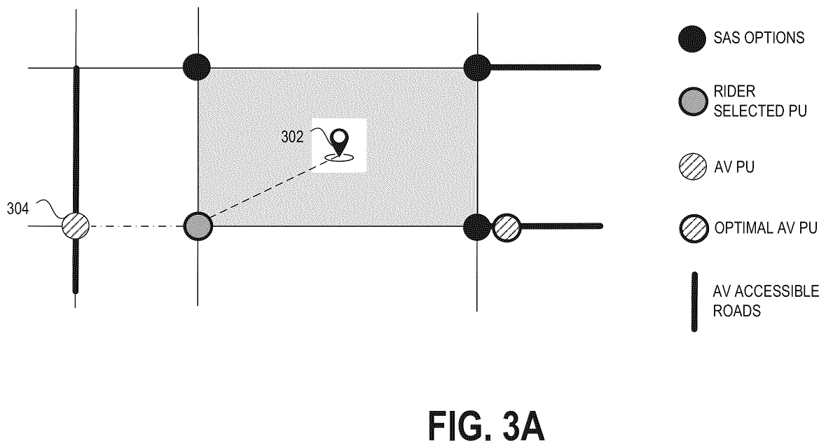

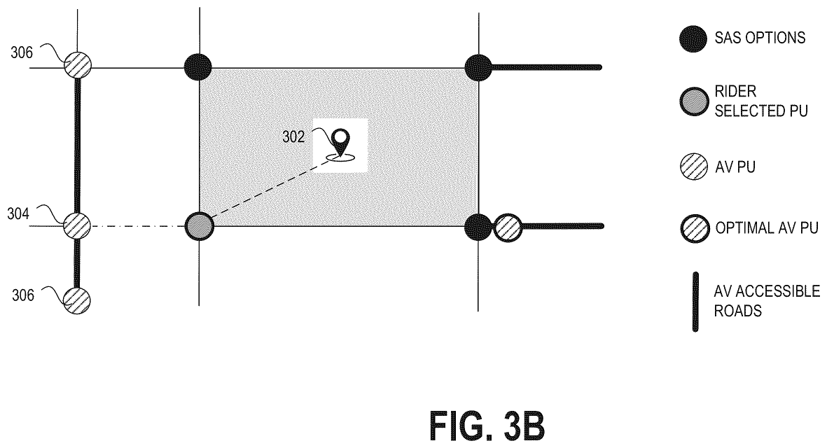

Referring to FIG. 3A, a diagram illustrating the above issue with this conventional implementation is shown. In particular, the diagram shows how lack of sharing a user's actual location (e.g., GPS coordinates of the user) negatively affects stopping location selection. A user is located in a center of a park (e.g., user location 302). Solid thick lines represent AV accessible roads and thus, where an AV can stop. At corners of the park are service assignment system (SAS) options (e.g., solid black circles) for pickup. In the example case, the service assignment system 102 provides the four SAS options to the user as suggested PUs, and the user selects one of the PUs. In the example of FIG. 3, the user selects the SAS option at the bottom left corner of the park. This selected PU is then sent by the service assignment system 102 to the third-party system 108.

Based on the selected PU, the third-party system 108 will find a closest stopping location to the selected PU (e.g., AV stopping 304) and may also provide a closest stopping location for a user selected DO. This selected AV stopping location 304 is still quite a walk from the (user) selected PU. The AV stopping location 304 does not account for how much distance a user will need to walk for their current location. Thus, a single AV stopping location may not provide flexibility to help users reduce walking effort. A user's walking effort expectation can be set at an offer stage where a user can visualize an amount of walking required at both a pickup and drop-off leg. A single stopping location received from the third-party system 108 may not take the actual ride location 302 into account. Additionally, given that the user location 302 is dynamic, it may also be challenging to include the user location 302 in a validation flow between the service assignment system 102 and the third-party system 108.

If the user location 302 was provided instead to the third-party system 108, the third-party system 108 will likely return a stopping location located near a bottom right corner of the park. As a result of not sharing the user location 302, the user needs to walk almost twice as far to reach the AV in this example.

Since sharing user location data (e.g., GPS coordinates) is a sensitive matter, an alternative approach is to request multiple AV stopping locations from the third-party system 108. The service assignment system 102 can then select the best AV stopping location with respect to walking effort for the user. However, even in the case of receiving multiple AV stopping locations 306, as shown in FIG. 3B, the selected AV stopping location 304 (connected by dotted line to the user selected PU) may still be suboptimal since the third-party system 108 is not considering the user location 302 when determining the multiple AV stopping locations to provide to the service assignment system 102. Even though the third-party system 108 is providing multiple AV stopping locations 306, these multiple AV stopping locations 306 are based on the user selected PU and not based on the user location 302. As a result, an optimal AV stopping location is still not returned by the third-party system 108.

From a user's perspective, the user has already selected a PU at the time of the transportation request and any PU changes will be a surprise. While human drivers can almost always get close to their riders (e.g., users), walking for AV rides is already a surprise. Given most users are new to AV technology, this subpar experience has a potential to create a lasting user perception that AVs are unable to park close to them and are a worse option than a car driver by a human. Additionally, by not obtaining multiple stopping locations, the service assignment system 102 does not have a capability to make stopping location choices, which makes a key part of the user experience highly dependent on the third-party system 108.

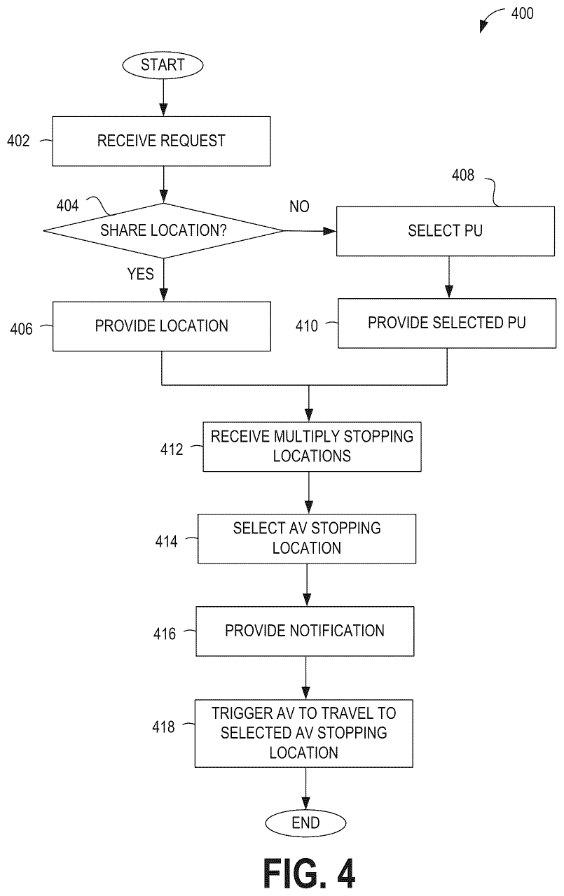

Example implementations provide a technical advantage to the conventional implementation by using a combination of selective user location sharing and service assignment system 102 selection, based on an objective function, of an AV PU from multiple AV PUs returned by the third-party system 108. FIG. 4 is a flowchart illustrating a method 400 for selectively sharing user location and causing an AV to travel to a selected AV PU, according to example implementations. Operations in the method 400 may be performed by the service assignment system 102 as described above in part with respect to FIG. 1. Accordingly, the method 400 is described by way of example with reference to the service assignment system 102. However, it shall be appreciated that at least some of the operations of the method 400 may be deployed on various other hardware configurations or be performed by similar components residing elsewhere in the environment 100. Therefore, the method 400 is not intended to be limited to the service assignment system 102. Further still, while the method 400 is described primarily with respect to a PU, similar operations can be performed for a DO.

In example implementations, the method 400 can obtain multiple AV PUs or stopping locations from the third-party system 108 based on an anchor point that may be derived as an objective function by the service assignment system 102. In particular, the objective function determines whether a user actual location (e.g., GPS coordinates) or a user selected PU should be shared with the third-party system 108. A further objective function selects an optimal AV stopping location from multiple stopping locations returned by the third-party system 108.

In operation 402, a service request for transportation service is received from a user (e.g., a potential rider). The transportation service may include transporting a payload, such as cargo and/or one or more passengers. In some examples, the service request includes a location of the user (e.g., GPS coordinates detected by a sensor in the user computing device 106), while in other cases, the receipt of the service request causes the service assignment system 102 to detect the user's location via their user computing device 106. In some examples, the service request (or subsequent exchange of information via the UI 122) includes a user selected PU. The user selected PU can be selected from options presented to the user by the service assignment system 102 and/or be selected by the user moving a PU point icon (e.g., a pin) on a map displayed on the UI 122.

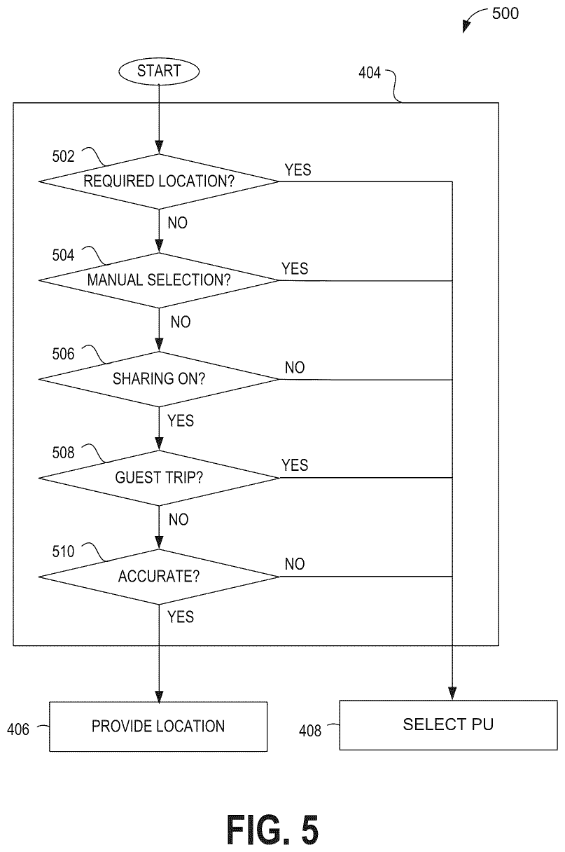

In operation 404, the service assignment system 102 makes a determination whether to share the actual detected location of the user. In example implementations, the sharing can occur at one or more different times during a transportation service process. In a first option, the user's location can be shared at booking time (e.g., when a user sends a request for transportation service). This allows for the service assignment system 102 to factor in true walking effort of the user in filtering out AV stopping locations that fall outside of a walking threshold. In a second option, the user's location can be shared after the user is matched to an AV that will be providing the transportation service. With this option, the third-party system 108 can offer a stopping location closest to the user's actual location. In a third option, the user's location can be shared during rendezvous between the AV and the user. For example, live updating GPS coordinates of the user's location as the AV approaches the stopping location can be shared with the third-party system 108. This will enable the AV to account for the user's actual GPS location and not to stray too far from the user during last minute stopping location changes it makes (e.g., finding parking, traffic). Additionally, the AV can take into account details such as a side of the street the user is standing. Operation 404 will be discussed in more detail in connection with FIG. 5 below.

If the service assignment system 102 determines that the user location of the user can be shared with the third-party system 108, then the user location is provided as the pickup location (PU) associated with the user, with the PU selected by the user, or as a blending of the user location and the PU selected by the user in operation 406. In some examples, the user location comprises GPS coordinates of the user location. In some examples, the user location comprises the GPS coordinates obfuscated by a value (e.g., ±5 meters). While GPS is discussed herein, alternative implementations can utilize other navigation systems and coordinates.

If in operation 404, the service assignment system 102 determines that the user's location should not be shared with the third-party system 108, then in operation 408, the service assignment system 102 selects a PU to provide to the third-party system 108 and provides the selected PU in operation 410. In the case where the user selects a PU, the service assignment system 102 can provide the user selected PU. In some examples, the PU is selected by the user from one or more options suggested by the service assignment system 102. In some examples, the PU is selected by the user manually moving a PU point icon (e.g., a pin) on a map displayed on the UI 122. In some implementations, the service assignment system 102 selects the PU based, in part, on regulations/limitations associated with a locale. For example, an airport or hotel will have designated areas where PUs have to occur.

If none of the above examples apply, the service assignment system 102 can use an internal optimization logic or algorithm which will look at all the available PU and select the best one to provide to the third-party system 108. Even though the user's location is not being shared with the third-party system, the service assignment system 102 is still aware of the user's location. As such, the service assignment system 102 can identify a PU that is, for example, closest to the user's location that satisfies various conditions or user preferences such as, not requiring the user to cross a busy street or a lot of intersections.

It is noted that the one or more options suggested by the service assignment system 102 from which the user can select can also be determined using the internal optimization logic or algorithm. Thus, the one or more options can be optimized for the user prior to user selection.

In some examples, the service assignment system 102 can provide an area instead of coordinates of a selected PU to the third-party system 108. For example, the service assignment system 102 can provide a bounding box for an area in which the user is located and ask for multiple stopping locations for the area.

In some cases, only one communication (e.g., API call) is sent to the third-party system 108 in order to receive multiple stopping locations. In other cases, multiple communications can be sent to the third-party system 108 in order to receive a stopping location in response to each communication. Further still, multiple communications can be sent to multiple third-party systems. The communications can, for example, request different AVs or types of AVs. Because different AVs can have different operational constraints including, for example, stopping location constraints, the stopping locations received can be different based on the AVs. Further still, the multiple communications can provide different stopping locations. For example and referring to FIG. 3A, a first communication can include a selected PU at the bottom left corner of the park while a second communication includes a selected PU at the bottom right corner of the park.

In operation 412, the service assignment system 102 receives multiple stopping locations from the third-party system 108 unless there is only a single stopping location applicable. In some examples, the multiple stopping locations are conditional on a particular AV. Thus, the multiple stopping locations are a per AV set of candidates for the particular user or service request. The multiple stopping locations can be generated by the third-party system 108 or by each AV.

In operation 414, the service assignment system 102 selects an AV stopping location based on the multiple stopping locations received in operation 412. In some examples, the service assignment system 102 performs an optimization process to determine which stopping location makes the most sense from the user's perspective. In example implementations, the service assignment system 102 applies an objective function that considers walking distance, walking difficulty, walking time to stopping location, and/or decreased time to travel to the drop-off location (e.g., because the user can reach the stopping location faster and start the transportation service quicker). The service assignment system 102 also wants to avoid walking routes where the user needs to cross a lot of intersections or crossing a busy road, especially at night, for example. All of these parameters can be weighted for each of the candidate AV stopping locations and whichever has the highest score will be selected. For example, if walking time, walking time to stopping location, and/or arrival at drop-off time can be reduced, then the score will be higher.

In some examples, the user's preferences can also be used in selecting the stopping location. For example, the user's preferences can indicate whether decreased walking time, decreased distance, or faster pickup is important to the user. The service assignment system 102 can then weigh those preferences higher in determining the score. The user's preference can be derived from past transportation services or be explicitly indicated by the user and stored to their profile.

In some examples, instead of the service assignment system 102 selecting the AV stopping location from the multiple stopping locations, the service assignment system 102 presents the multiple AV stopping locations to the user and allows the user to select the AV stopping location. For instance, the multiple AV stopping locations can be displayed on a map on the UI 122. The user can then, for example, tap on an icon representing an AV stopping location to select that AV stopping location.

In operation 416, notification of the selected AV stopping location is provided by the service assignment system 102. For example, the user's UI 122 is updated to show the selected AV stopping location and a time of arrival of the AV to the AV stopping location. Additionally, a notification can be sent to the third-party system 108 indicating the selected AV stopping location. This notification can then be passed on to the AV by the third-party system 108.

In operation 418, the selection of the AV stopping location triggers the AV to travel to the selected AV stopping location to pick up the user or cargo. After picking up the user or cargo, the AV then travels to the DO (e.g., a second stopping location).

FIG. 5 is a flowchart illustrating a method 500 of determining whether to share the actual detected location of the user with the third-party system 108, according to example implementations. Operations in the method 500 may be performed by the service assignment system 102 as described above in part with respect to FIG. 1. Accordingly, the method 500 is described by way of example with reference to the service assignment system 102. However, it shall be appreciated that at least some of the operations of the method 500 may be deployed on various other hardware configurations or be performed by similar components residing elsewhere in the environment 100. Therefore, the method 500 is not intended to be limited to the service assignment system 102.

In operation 502, the service assignment system 102 determines whether a service request is associated with a required location. In certain locales, regulations or limitations are in place that restrict where AVs can stop. For example, airports and hotels may have designated ride share pickup areas. If the service request is from a user requesting a pickup from one of these locales, the service assignment system 102 determines that the request and/or the user is associated with a required location. As such, the service assignment system 102 determines the stopping location (e.g., PU) in operation 408. Specifically, the service assignment system selects the required location (e.g., designated ride share pickup area) associated with the locale as the selected PU. Required locations for different locales may be stored in a database accessible to the service assignment system 102. In some cases, the required locations are received, for example, from the locales themselves or from a system that manages a database of required locations.

If the service assignment system 102 determines that a required location is not involved in operation 502, then the method 500 proceeds to operation 504 where the service assignment system 102 determines whether there has been a manual selection of a PU by the user. In some examples, the PU is selected by the user from one or more options suggested by the service assignment system 102. In other examples, the PU is selected by the user manually moving a PU icon (e.g., a pin) on a map displayed on the UI 122. If the user has manually selected a PU, then the user selected PU is the selected PU in operation 408.

If the service assignment system 102 determines that a user has not manually selected the PU, then the method 500 proceeds to operation 506 where the service assignment system 102 determines whether the user has turn on location sharing. When booking a trip, the user can decide if they want to share their location (e.g., set in user preferences). If sharing is not turned on, then the method 500 proceeds to operation 408 where the service assignment system 102 may select the PU on behalf of the user.

If sharing is turned on, then in operation 508, the service assignment system 102 determines whether the service request is for a guest trip. A guest trip is when the user is not near the requested PU (e.g., service start point). For example, the user can be booking transportation service for someone else. If the service request if associated with a guest trip, then the method 500 proceeds to operation 408 where the service assignment system 102 selects the PU on behalf of the user.

If the request service request is not associated with a guest trip, then the method 500 proceeds to operation 510 in which the service assignment system 102 determines whether a detected location of the user (e.g., GPS location) received from a device of the user is accurate. For example, the detected location can have a lot of noise. In one example, a GPS signal can be map-matched to a closest road segment to determine accuracy. In another example, the service assignment system 102 can use a tail of the latest GPS coordinates to smooth out where a best guess is to a true location. Further still, accuracy can be based on specific signals produced by the GNSS (global navigation satellite system) hardware on the user's device generating the GPS coordinates. If accuracy is good, then the detected location of the user is provided in operation 406. If the detected location of the user is not accurate, then the method 500 proceeds to operation 408, in which the service assignment system 102 selects the PU.

In some implementations, the select PU can be shared along with the detected user location (e.g., GPS coordinates) of the user. For example, the service assignment system 102 can provide the required location or the manually selected stopping location with the detected user location. This may be useful, for example, when the user may not be physically near the selected PU or within a reasonable walking distance/time to the selected PU. For instance, the user may have manually selected a PU that is too far for the user to walk to or will cause the AV to have to wait a long period of time at for the user to walk to. By providing the detected user location, the third-party system 108 (or AV) or the service assignment system 102 can suggest or select an alternative AV stopping location that is closer to the user.

As noted above, the detected user location can be shared at different times during a transportation service or multiple times during the transportation service. For example, the user location can be shared with the third-party system 108 when matching the user to an AV that will provide the service. Additionally or alternatively, while the user is waiting for the AV to arrive, the user location can be shared and the AV (or third-party system 108) detects that the AV cannot stop at the user location. Further still, the user location can be shared if the service assignment system 102 detects that the user may not reach the selected AV stopping location prior to arrival of the AV. Multiple stopping locations may be returned by the third-party system 108 to the service assignment system 102. A new AV stopping location can be determined by the service assignment system 102 or the multiple stopping locations shown on the UI 122 and the user allowed to select a new AV stopping location.

FIG. 6 is a block diagram 600 showing one example of a software architecture 602 for a computing device. The software architecture 602 may be used in conjunction with various hardware architectures, for example, as described herein. FIG. 6 is merely a non-limiting example of a software architecture 602, and many other architectures may be implemented to facilitate the functionality described herein. A representative hardware layer 604 is illustrated and can represent, for example, any of the above-referenced computing devices. In some examples, the hardware layer 604 may be implemented according to a hardware architecture, such as the hardware architecture of FIG. 7 and/or the software architecture 602 of FIG. 6.

The representative hardware layer 604 comprises one or more processing units 606 having associated executable instructions 608. The executable instructions 608 represent the executable instructions of the software architecture 602, including implementation of the methods, modules, components, and so forth. The hardware layer 604 also includes memory and/or storage modules 610, which also have the executable instructions 608. The hardware layer 604 may also comprise other hardware 612, which represents any other hardware of the hardware layer 604, such as the other hardware illustrated as part of the hardware architecture 400.

In the example architecture of FIG. 6, the software architecture 602 may be conceptualized as a stack of layers where each layer provides particular functionality. For example, the software architecture 602 may include layers such as an operating system 614, libraries 616, middleware layer 618, applications 620, and a presentation layer 644. Operationally, the applications 620 and/or other components within the layers may invoke application programming interface (API) calls 624 through the software stack and receive a response, returned values, and so forth illustrated as messages 626 in response to the API calls 624. The layers illustrated are representative in nature, and not all software architectures have all layers. For example, some mobile or special-purpose operating systems may not provide a middleware layer 618, while others may provide such a layer. Other software architectures may include additional or different layers.

The operating system 614 may manage hardware resources and provide common services. The operating system 614 may include, for example, a kernel 628, services 630, and drivers 632. The kernel 628 may act as an abstraction layer between the hardware and the other software layers. For example, the kernel 628 may be responsible for memory management, processor management (e.g., scheduling), component management, networking, security settings, and so on. The services 630 may provide other common services for the other software layers. In some examples, the services 630 include an interrupt service. The interrupt service may detect the receipt of a hardware or software interrupt and, in response, cause the software architecture 602 to pause its current processing and execute an interrupt service routine (ISR) when an interrupt is received. The ISR may generate an alert.

The drivers 632 may be responsible for controlling or interfacing with the underlying hardware. For instance, the drivers 632 may include display drivers, camera drivers, Bluetooth® drivers, flash memory drivers, serial communication drivers (e.g., Universal Serial Bus (USB) drivers), Wi-Fi® drivers, near-field communication (NFC) drivers, audio drivers, power management drivers, and so forth depending on the hardware configuration.

The libraries 616 may provide a common infrastructure that may be used by the applications 620 and/or other components and/or layers. The libraries 616 typically provide functionality that allows other software modules to perform tasks in an easier fashion than by interfacing directly with the underlying operating system 614 functionality (e.g., kernel 628, services 630, and/or drivers 632). The libraries 616 may include system libraries 634 (e.g., C standard library) that may provide functions such as memory allocation functions, string manipulation functions, mathematic functions, and the like. In addition, the libraries 616 may include API libraries 636 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 616 may also include a wide variety of other libraries 638 to provide many other APIs to the applications 620 and other software components/modules.

The middleware layer 618 (also sometimes referred to as frameworks) may provide a higher-level common infrastructure that may be used by the applications 620 and/or other software components/modules. For example, the middleware layer 618 may provide various graphical user interface (GUI) functions, high-level resource management, high-level location services, and so forth. The middleware layer 618 may provide a broad spectrum of other APIs that may be used by the applications 620 and/or other software components/modules, some of which may be specific to a particular operating system or platform.

The applications 620 include built-in applications 640 and/or third-party applications 642. Examples of representative built-in applications 640 may include, but are not limited to, a contacts application, a browser application, a book reader application, a location application, a media application, a messaging application, and/or a game application. The third-party applications 642 may include any of the built-in applications 640 as well as a broad assortment of other applications. In a specific example, the third-party application 642 (e.g., an application developed using the Android™ or iOS™ software development kit (SDK) by an entity other than the vendor of the particular platform) may be mobile software running on a mobile operating system such as iOS™, Android™, Windows® Phone, or other computing device operating systems. In this example, the third-party application 642 may invoke the API calls 624 provided by the mobile operating system such as the operating system 614 to facilitate functionality described herein.

The applications 620 may use built-in operating system functions (e.g., kernel 628, services 630, and/or drivers 632), libraries (e.g., system libraries 634, API libraries 636, and other libraries 638), or middleware layer 618 to create user interfaces to interact with users of the system. Alternatively, or additionally, in some systems, interactions with a user may occur through a presentation layer, such as the presentation layer 644. In these systems, the application/module “logic” can be separated from the aspects of the application/module that interact with a user.

Some software architectures use virtual machines. For example, systems described herein may be executed using one or more virtual machines executed at one or more server computing machines. In the example of FIG. 6, this is illustrated by a virtual machine 648. A virtual machine creates a software environment where applications/modules can execute as if they were executing on a hardware computing device. The virtual machine 648 is hosted by a host operating system (e.g., the operating system 614) and typically, although not always, has a virtual machine monitor 646, which manages the operation of the virtual machine 648 as well as the interface with the host operating system (e.g., the operating system 614). A software architecture executes within the virtual machine 648, such as an operating system 650, libraries 652, frameworks/middleware 654, applications 656, and/or a presentation layer 658. These layers of software architecture executing within the virtual machine 648 can be the same as corresponding layers previously described or may be different.

FIG. 7 illustrates components of a machine 700, according to some example implementations, that is able to read instructions from a machine-storage medium (e.g., a machine-storage device, a non-transitory machine-storage medium, a computer-storage medium, or any suitable combination thereof) and perform any one or more of the methodologies discussed herein. Specifically, FIG. 7 shows a diagrammatic representation of the machine 700 in the example form of a computer device (e.g., a computer) and within which instructions 724 (e.g., software, a program, an application, an applet, an app, or other executable code) for causing the machine 700 to perform any one or more of the methodologies discussed herein may be executed, in whole or in part.

For example, the instructions 724 may cause the machine 700 to execute the flow diagrams of FIG. 4 and FIG. 5. In one implementation, the instructions 724 can transform the machine 700 into a particular machine (e.g., specially configured machine) programmed to carry out the described and illustrated functions in the manner described.

In alternative implementations, the machine 700 operates as a standalone device or may be connected (e.g., networked) to other machines. In a networked deployment, the machine 700 may operate in the capacity of a server machine or a client machine in a server-client network environment, or as a peer machine in a peer-to-peer (or distributed) network environment. The machine 700 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 724 (sequentially or otherwise) that specify actions to be taken by that machine. Further, while only a single machine is illustrated, the term “machine” shall also be taken to include a collection of machines that individually or jointly execute the instructions 724 to perform any one or more of the methodologies discussed herein.

The machine 700 includes a processor 702 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 704, and a static memory 706, which are configured to communicate with each other via a bus 708. The processor 702 may contain microcircuits that are configurable, temporarily or permanently, by some or all of the instructions 724 such that the processor 702 is configurable to perform any one or more of the methodologies described herein, in whole or in part. For example, a set of one or more microcircuits of the processor 702 may be configurable to execute one or more components described herein.

The machine 700 may further include a graphics display 710 (e.g., a plasma display panel (PDP), a light emitting diode (LED) display, a liquid crystal display (LCD), a projector, or a cathode ray tube (CRT), or any other display capable of displaying graphics or video). The machine 700 may also include an input device 712 (e.g., a keyboard), a cursor control device 714 (e.g., a mouse, a touchpad, a trackball, a joystick, a motion sensor, or other pointing instrument), a storage unit 716, a signal generation device 718 (e.g., a sound card, an amplifier, a speaker, a headphone jack, or any suitable combination thereof), and a network interface device 720.

The storage unit 716 includes a machine-storage medium 722 (e.g., a tangible machine-storage medium) on which is stored the instructions 724 (e.g., software) embodying any one or more of the methodologies or functions described herein. The instructions 724 may also reside, completely or at least partially, within the main memory 704, within the processor 702 (e.g., within the processor's cache memory), or both, before or during execution thereof by the machine 700. Accordingly, the main memory 704 and the processor 702 may be considered as machine-storage media (e.g., tangible and non-transitory machine-storage media). The instructions 724 may be transmitted or received over a network 726 via the network interface device 720.

In some example implementations, the machine 700 may be a portable computing device and have one or more additional input components (e.g., sensors or gauges). Examples of such input components include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the components described herein.

### Executable Instructions and Machine-Storage Medium

The various memories (e.g., 704, 706, and/or memory of the processor(s) 702) and/or storage unit 716 may store one or more sets of instructions and data structures (e.g., software) 724 embodying or utilized by any one or more of the methodologies or functions described herein. These instructions, when executed by processor(s) 702 cause various operations to implement the disclosed implementations.

As used herein, the terms “machine-storage medium,” “device-storage medium,” “computer-storage medium” (referred to collectively as “machine-storage medium 722”) mean the same thing and may be used interchangeably in this disclosure. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, for example, erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms machine-storage medium or media, computer-storage medium or media, and device-storage medium or media specifically exclude carrier waves, modulated data signals, and other such media, at least some of which are covered under the term “signal medium” discussed below. In this context, the machine-storage medium is non-transitory.

### Signal Medium

The term “signal medium” or “transmission medium” shall be taken to include any form of modulated data signal, carrier wave, and so forth. The term “modulated data signal” means a signal that has one or more of its characteristics set or changed in such a matter as to encode information in the signal.

### Computer Readable Medium

The terms “machine-readable medium,” “computer-readable medium” and “device-readable medium” mean the same thing and may be used interchangeably in this disclosure. The terms are defined to include both machine-storage media and signal media. Thus, the terms include both storage devices/media and carrier waves/modulated data signals.

The instructions 724 may further be transmitted or received over a communications network 726 using a transmission medium via the network interface device 720 and utilizing any one of a number of well-known transfer protocols (e.g., HTTP). Examples of communication networks 726 include a local area network (LAN), a wide area network (WAN), the Internet, mobile telephone networks, plain old telephone service (POTS) networks, and wireless data networks (e.g., Wi-Fi, LTE, and WiMAX networks). The term “transmission medium” shall be taken to include any intangible medium that is capable of storing, encoding, or carrying instructions 724 for execution by the machine 700, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components.

A “hardware component” is a tangible unit capable of performing certain operations and may be configured or arranged in a certain physical manner. In various example implementations, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein.

In some implementations, a hardware component may be implemented mechanically, electronically, or any suitable combination thereof. For example, a hardware component may include dedicated circuitry or logic that is permanently configured to perform certain operations. For example, a hardware component may be a special-purpose processor, such as a field programmable gate array (FPGA) or an ASIC. A hardware component may also include programmable logic or circuitry that is temporarily configured by software to perform certain operations. For example, a hardware component may include software encompassed within a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where the hardware component comprises a general-purpose processor configured by software to become a special-purpose processor, the general-purpose processor may be configured as respectively different special-purpose processors (e.g., comprising different hardware components) at different times. Software may accordingly configure a processor, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors.

Similarly, the methods described herein may be at least partially processor-implemented, a processor being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example implementations, the one or more processors or processor-implemented components may be located in a single geographic location (e.g., within a home environment, an office environment, or a server farm). In other example implementations, the one or more processors or processor-implemented components may be distributed across a number of geographic locations.

### Examples

Example 1 is a method for providing transportation service using an autonomous vehicle (AV) of a third-party system based on multiple stopping locations. The method comprises receiving, by a service assignment system from a computing device of a user, a service request from the user for a transportation service; providing, by the service assignment system to the third-party system, a pickup location associated with the user; in response to providing the pickup location associated with the user, receiving multiple AV stopping locations from the third-party system; selecting an AV stopping location from the multiple AV stopping locations; and in response to the selecting, triggering the AV of the third-party system to travel to the selected AV stopping location.

In example 2, the subject matter of example 1 can optionally include wherein the providing the pickup location associated with the user comprises determining whether to share a user location of the user with the third-party system; and based on the determining, providing the user location of the user and/or a selected pickup location to the third-party system, the selected pickup location comprising a pickup location selected by the service assignment system or the user.

In example 3, the subject matter of any of examples 1-2 can optionally include wherein the determining whether to share the user location comprises determining whether the service request is associated with a required location based on restrictions that restrict where AVs can stop; and the providing comprises providing the required location based on the service request being associated with the require location.

In example 4, the subject matter of any of examples 1-3 can optionally include wherein the determining whether to share the user location comprises determining whether a manual selection of a pickup location was made by the user; and the providing comprises providing the manually selected pickup location.

In example 5, the subject matter of any of examples 1-4 can optionally include wherein the determining whether to share the user location comprises determining whether the user allows sharing of the user location; and based on the user allowing sharing of the user location, determining whether the user location of the user is accurate, wherein the providing comprises providing the user location is based on the location being accurate.

In example 6, the subject matter of any of examples 1-5 can optionally include wherein the determining whether to share the user location comprises determining whether the user allows sharing of the user location; based on the user allowing sharing of the user location, determining whether the user location of the user is accurate; and based on the user location not being accurate, determining, by the service assignment system, a pickup location closest to the user that satisfies one or more conditions or user preferences.

In example 7, the subject matter of any of examples 1-6 can optionally include wherein the determining whether to share the user location comprises determining whether the user allows sharing of the user location; and based on the user allowing sharing of the user location, determining whether the request is for a transportation service for a guest user, the guest user being an individual different from the user; and based on the transportation service being for a guest user, determining a pickup location associated with a location of the guest user.

In example 8, the subject matter of any of examples 1-7 can optionally include wherein the selecting the AV stopping location from the multiple AV stopping locations comprises applying, by the service assignment system, an objective function to the multiple AV stopping locations to generate weighted scores for each of the multiple AV stopping locations, the object function considering one or more of walking distance, walking difficulty, walking time to each of the multiple AV stopping locations, or decreased time to travel to a drop-off location.

In example 9, the subject matter of any of examples 1-8 can optionally include wherein the weighted scores are further based on user preferences of the user.

In example 10, the subject matter of any of examples 1-9 can optionally include wherein the weighted scores are further based on avoiding walking routes where the user needs to cross multiple intersections or cross a busy road.

In example 11, the subject matter of any of examples 1-10 can optionally include wherein the selecting the AV stopping location from the multiple AV stopping locations comprises causing presentation, on a user interface displayed on the computing device, of at least some of the multiple AV stopping locations; and receiving, via the user interface from the user, a selection of the AV stopping location from the multiple AV stopping locations.

In example 12, the subject matter of any of examples 1-11 can optionally include updating a user interface displayed on the computing device to show the selected AV stopping location and a time of arrival of the AV to the AV stopping location.

In example 13, the subject matter of any of examples 1-12 can optionally include wherein the determining whether to share occurs at a booking time prior to selection of the AV.

In example 14, the subject matter of any of examples 1-13 can optionally include detecting that the user has reached the selected AV stopping location and is waiting for arrival of the AV, wherein the determining whether to share is triggered based on the detecting that the user has reached the selected AV stopping location and is waiting.

In example 15, the subject matter of any of examples 1-14 can optionally include detecting that the user will not reach the selected AV stopping location prior to arrival of the AV at the selected AV stopping location, wherein the determining whether to share is triggered based on the detecting that the user will not reach the selected AV stopping location prior to arrive of the AV.

Example 16 is a system for providing transportation service using an autonomous vehicle (AV) of a third-party system based on multiple stopping locations. The system comprises one or more processors and a memory storing instructions that, when executed by the one or more processors, cause the one or more processors to perform operations comprising receiving, by a service assignment system from a computing device of a user, a service request from the user for a transportation service; providing, by the service assignment system to the third-party system, a pickup location associated with the user; in response to providing the pickup location associated with the user, receiving multiple AV stopping locations from the third-party system; selecting an AV stopping location from the multiple AV stopping locations; and in response to the selecting, triggering the AV of the third-party system to travel to the selected AV stopping location.

In example 17, the subject matter of example 16 can optionally include wherein the selecting the AV stopping location from the multiple AV stopping locations comprises applying, by the service assignment system, an objective function to the multiple AV stopping locations to generate weighted scores for each of the multiple AV stopping locations, the object function considering one or more of walking distance, walking difficulty, walking time to each of the multiple AV stopping locations, or decreased time to travel to a drop-off location.

In example 18, the subject matter of any of examples 16-17 can optionally include wherein the weighted scores are further based on user preferences of the user or based on avoiding walking routes where the user needs to cross multiple intersections or cross a busy road.

In example 19, the subject matter of any of examples 16-18 can optionally include wherein the selecting the AV stopping location from the multiple AV stopping locations comprises causing presentation, on a user interface displayed on the computing device, of at least some of the multiple AV stopping locations; and receiving, via the user interface from the user, a selection of the AV stopping location from the multiple AV stopping locations.

Example 20 is a machine-storage medium comprising instructions which, when executed by one or more processors of a machine, cause the machine to perform operations for providing transportation service using an autonomous vehicle (AV) of a third-party system based on multiple stopping locations. The operations comprise receiving, by a service assignment system from a computing device of a user, a service request from the user for a transportation service; providing, by the service assignment system to the third-party system, a pickup location associated with the user; in response to providing the pickup location associated with the user, receiving multiple AV stopping locations from the third-party system; selecting an AV stopping location from the multiple AV stopping locations; and in response to the selecting, triggering the AV of the third-party system to travel to the selected AV stopping location.

Some portions of this specification may be presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated other wise.

Although an overview of the present subject matter has been described with reference to specific examples, various modifications and changes may be made to these examples without departing from the broader scope of examples of the present invention. For instance, various examples or features thereof may be mixed and matched or made optional by a person of ordinary skill in the art. Such examples of the present subject matter may be referred to herein, individually or collectively, by the term “invention” merely for convenience and without intending to voluntarily limit the scope of this application to any single invention or present concept if more than one is, in fact, disclosed.

The examples illustrated herein are believed to be described in sufficient detail to enable those skilled in the art to practice the teachings disclosed. Other examples may be used and derived therefrom, such that structural and logical substitutions and changes may be made without departing from the scope of this disclosure. The Detailed Description, therefore, is not to be taken in a limiting sense, and the scope of various examples is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various examples of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of examples of the present invention as represented by the appended claims. The specification and drawings are, accordingly, to be regarded in an illustrative rather than a restrictive sense.

1. A method for providing transportation service using an autonomous vehicle (AV) of a third-party system based on multiple stopping locations, the method comprising:
receiving, by a service assignment system from a computing device of a user, a service request from the user for a transportation service;
providing, by the service assignment system to the third-party system, a pickup location associated with the user;
in response to providing the pickup location associated with the user, receiving multiple AV stopping locations from the third-party system;
selecting an AV stopping location from the multiple AV stopping locations; and
in response to the selecting, triggering the AV of the third-party system to travel to the selected AV stopping location.

2. The method of claim 1, wherein the providing the pickup location associated with the user comprises:
determining whether to share a user location of the user with the third-party system; and
based on the determining, providing the user location of the user and/or a selected pickup location to the third-party system, the selected pickup location comprising a pickup location selected by the service assignment system or the user.

3. The method of claim 2, wherein:
the determining whether to share the user location comprises determining whether the service request is associated with a required location based on restrictions that restrict where AVs can stop; and
the providing comprises providing the required location based on the service request being associated with the require location.

4. The method of claim 2, wherein:
the determining whether to share the user location comprises determining whether a manual selection of a pickup location was made by the user; and
the providing comprises providing the manually selected pickup location.

5. The method of claim 2, wherein the determining whether to share the user location comprises:
determining whether the user allows sharing of the user location; and
based on the user allowing sharing of the user location, determining whether the user location of the user is accurate, wherein the providing comprises providing the user location is based on the location being accurate.

6. The method of claim 2, wherein the determining whether to share the user location comprises:
determining whether the user allows sharing of the user location;
based on the user allowing sharing of the user location, determining whether the user location of the user is accurate; and
based on the user location not being accurate, determining, by the service assignment system, a pickup location closest to the user that satisfies one or more conditions or user preferences.

7. The method of claim 2, wherein the determining whether to share the user location comprises:
determining whether the user allows sharing of the user location; and
based on the user allowing sharing of the user location, determining whether the request is for a transportation service for a guest user, the guest user being an individual different from the user; and
based on the transportation service being for a guest user, determining a pickup location associated with a location of the guest user.

8. The method of claim 1, wherein the selecting the AV stopping location from the multiple AV stopping locations comprises:
applying, by the service assignment system, an objective function to the multiple AV stopping locations to generate weighted scores for each of the multiple AV stopping locations, the object function considering one or more of walking distance, walking difficulty, walking time to each of the multiple AV stopping locations, or decreased time to travel to a drop-off location.

9. The method of claim 8, wherein the weighted scores are further based on user preferences of the user.

10. The method of claim 8, wherein the weighted scores are further based on avoiding walking routes where the user needs to cross multiple intersections or cross a busy road.

11. The method of claim 1, wherein the selecting the AV stopping location from the multiple AV stopping locations comprises:
causing presentation, on a user interface displayed on the computing device, of at least some of the multiple AV stopping locations; and
receiving, via the user interface from the user, a selection of the AV stopping location from the multiple AV stopping locations.

12. The method of claim 1, further comprising updating a user interface displayed on the computing device to show the selected AV stopping location and a time of arrival of the AV to the AV stopping location.

13. The method of claim 1, wherein the determining whether to share occurs at a booking time prior to selection of the AV.

14. The method of claim 2, further comprising:
detecting that the user has reached the selected AV stopping location and is waiting for arrival of the AV, wherein the determining whether to share is triggered based on the detecting that the user has reached the selected AV stopping location and is waiting.

15. The method of claim 2, further comprising:
detecting that the user will not reach the selected AV stopping location prior to arrival of the AV at the selected AV stopping location, wherein the determining whether to share is triggered based on the detecting that the user will not reach the selected AV stopping location prior to arrive of the AV.

16. A system for providing transportation service using an autonomous vehicle (AV) of a third-party system based on multiple stopping locations, the system comprising:
one or more processors; and
a memory storing instructions that, when executed by the one or more processors, cause the one or more processors to perform operations comprising:
receiving, by a service assignment system from a computing device of a user, a service request from the user for a transportation service;
providing, by the service assignment system to the third-party system, a pickup location associated with the user;
in response to providing the pickup location associated with the user, receiving multiple AV stopping locations from the third-party system;
selecting an AV stopping location from the multiple AV stopping locations; and
in response to the selecting, triggering the AV of the third-party system to travel to the selected AV stopping location.

17. The system of claim 16, wherein the selecting the AV stopping location from the multiple AV stopping locations comprises:
applying, by the service assignment system, an objective function to the multiple AV stopping locations to generate weighted scores for each of the multiple AV stopping locations, the object function considering one or more of walking distance, walking difficulty, walking time to each of the multiple AV stopping locations, or decreased time to travel to a drop-off location.

18. The system of claim 16, wherein the weighted scores are further based on user preferences of the user or based on avoiding walking routes where the user needs to cross multiple intersections or cross a busy road.

19. The system of claim 16, wherein the selecting the AV stopping location from the multiple AV stopping locations comprises:
causing presentation, on a user interface displayed on the computing device, of at least some of the multiple AV stopping locations; and
receiving, via the user interface from the user, a selection of the AV stopping location from the multiple AV stopping locations.

20. A machine-storage medium comprising instructions which, when executed by one or more processors of a machine, cause the machine to perform operations for providing transportation service using an autonomous vehicle (AV) of a third-party system based on multiple stopping locations, the operations comprising:
receiving, by a service assignment system from a computing device of a user, a service request from the user for a transportation service;
providing, by the service assignment system to the third-party system, a pickup location associated with the user;
in response to providing the pickup location associated with the user, receiving multiple AV stopping locations from the third-party system;
selecting an AV stopping location from the multiple AV stopping locations; and
in response to the selecting, triggering the AV of the third-party system to travel to the selected AV stopping location.
